(19) United States
(12) Patent Application Publication
(10) Pub. No.: US 2008/0243918 A1
(43) Pub. Date: Oct. 2, 2008

(54) System and Method For Supporting Improved Trick Mode Performance For Disc Based Multimedia Content

(75) Inventor: Koen J.G. Holtman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,375

(22) PCT Filed: Mar. 25, 2005
(86) PCT No.: PCT/IB2005/051042

§ 371 Date: Aug. 25, 2006

Related U.S. Application Data
(60) Provisional application No. 60/557,498, filed on Mar. 30, 2004.

(51) Int. Cl. G06F 17/30

(52) U.S. Cl. 707/104.1; 707/E17.009

(57) ABSTRACT

A playback apparatus for use in a reproducing system is disclosed. The playback apparatus includes a number of conventional elements including a memory configured to store data to be read from a data source (1), a presentation unit (340) configured to retrieve one or more data blocks from the memory for presentation to a user and a controller (365) configured to manage the contents of the memory and control the operations of said data source (1). In addition to the conventional elements, the controller further comprises an access prediction unit (370) comprised of a ranking unit (360) and a candidate identifier unit (355). The candidate identifier unit (355) is configured to select a set of candidate blocks (at least two data blocks) from a plurality of data blocks stored on the data source for consideration by the ranking unit (360). The ranking unit (360) is operable to rank the desirability of a set of candidate blocks from among the plurality of data blocks stored on the data source. In one embodiment, the ranking unit (360) assigns a desirability ranking based on criteria comprising: (i) each of the at least two candidate data blocks predicted future use in at least two play modes and (ii) the relative ranking of the at least two of play modes.

The present invention relates to video recorder and playback systems, and more particularly to an optical disk playback system and improved trick-mode performance therein. The description which follows uses the terminology defined below:

MPEG (Motion Picture Experts Group)—is the name given to a family of International Standards used for coding audio-visual information in a digital compressed format. MPEG standards include MPEG-1, MPEG-2 and MPEG-4, to suit different bandwidth and quality constraints. MPEG-2, for example, is especially suited to the storage and transmission of broadcast quality television programs.

Fragment—a portion of an MPEG stream. Typically every 15^{th} frame of an MPEG stream is encoded as an 1 frame. A fragment is defined as either an I-frame, or that portion of an MPEG stream between two consecutive encoded I frames boundaries having typically 14 frames of information in-between.

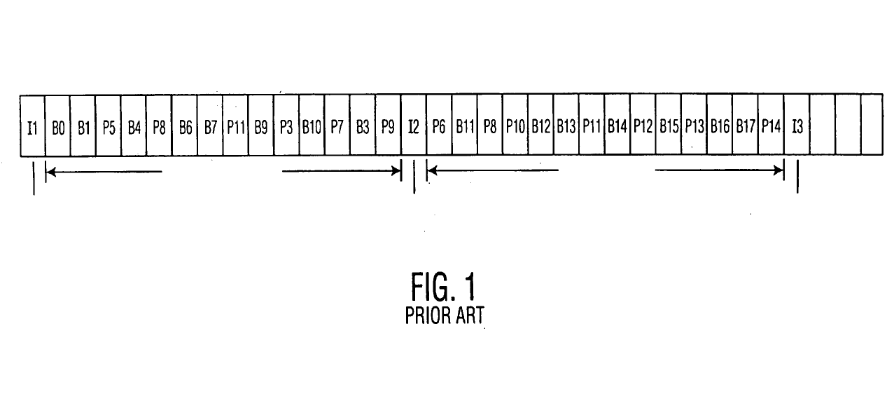

FIG. 1 is an illustration of an exemplary MPEG data stream illustrating five fragments 101-105. As shown, frames 11, 12, and 13 represent fragments 101, 103 and 105, respectively and fragments 102 and 104 are comprised of 14 frames of information bounded on either side by I frames. It is noted that in some implementations, fragment boundaries will not coincide exactly with the byte positions where an I-frame begins or ends, but positioned somewhat before or after these byte positions so as to be in alignment with optical disc sector boundaries.

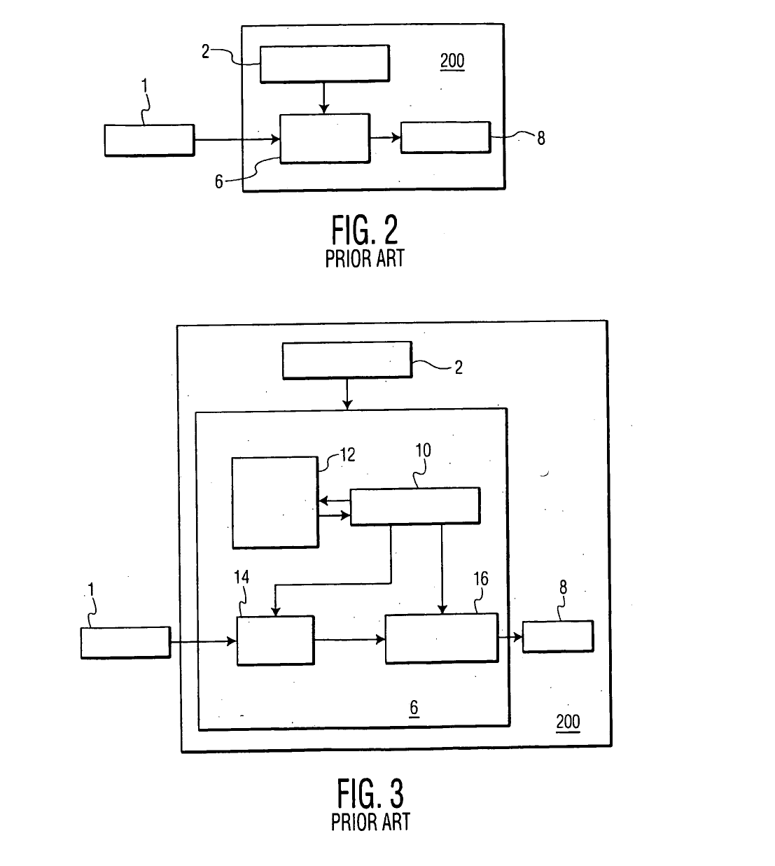

FIG. 2 is a high-level block diagram of a prior art optical disk reproducing system 200 for playing back an Optical Disc. The optical disk reproducing system 200 comprises a user interface 2, a playback unit 6 and an external display 8. The optical disk reproducing system 200 provides playback of the optical disk, inserted in disc drive 1, in either forward or reverse directions at speeds slower or faster than a normal playback speed. Such non-standard speed playback features are known in the art as trick modes or trick play (e.g., fast-forward, pause, rewind, etc.). Playback unit 6 is primarily responsible for executing the various playback features including the trick modes. An example of a trick mode is skipping of selected frames so as to obtain a fast forward mode. Another example of a trick mode could be accessing a contiguous sequence of frames repeatedly, commonly referred to as A-B loop play. The disk reproduction system 200 also has a user interface structure 2 to accept user instructions for the system 200. The user interface structure is comprised for instance of operating switches and buttons, remote controller, keyboard and liquid crystal display devices, etc.

FIG. 3 is a more detailed block diagram of the playback unit 6 of the reproducing system 200 of FIG. 2 in accordance with the prior art. The playback unit 6 comprises a controller 10 for controlling all disk related operations, a current playback position unit 12 that is used by the controller to hold the current position where the playback happens, a FIFO buffer 14 for storing fragments which may be requested by the presentation unit 16 for display on the display 8. The controller 10 controls the playback (including trick mode playback) of the data stored on the optical disk in the disc drive 1. The controller 10 may be included within a single device or separate devices. The controller 10 is bi-directionally coupled to the current playback position unit 12 which provides a ‘current playback position’ pointer to the controller 10. The current playback position pointer is moved forward and backward to determine the next video fragment to be read from the optical disk.

In normal ‘play’ mode, the pointer is moved forward in a linear fashion without ‘jumps’. In a ‘fast’ trick mode the pointer skips portions of the material. The skipping distance is either constant (e.g., in Fast-Forward every 4^{th} I frame which is equivalent to 60 frames), or controlled via a feedback loop. The disc drive 1 receives commands from the controller 10 to read a fragment of information of a certain size from a certain location on the optical disk. The fragments that are read are pushed into the FIFO buffer 14 which eventually passes the fragments on to the presentation unit 16 for display on the external display device 8.

The conventional optical disk reproducing system 200 of FIGS. 2 and 3 suffers from a number of drawbacks including: (1) the execution of efficient (i.e. fast) transitions between the different trick modes requires a relatively complicated controller 10; (2) transitions from one mode to another present problems related to storage, control, latency and timing, all of which demand a significant investment of design, coding, debugging, and tuning time; and (3) the controller has difficulty dealing with data streams that are not stored fully sequentially on a disc or similar storage medium. If a ‘gap’ in the data stream must be crossed by the disc drive, this may lead to delays that could cause a FIFO buffer underrun. Buffer underrun occurs when the disk reproducing system fails to sustain the data stream from the optical disk for the duration of the reproduction process (this may be overcome by using a more complex controller or by using a presentation unit that can deal with an empty FIFO buffer) and (4) in the case of A-B loop play, when the points A and B are very close together, it becomes a difficult situation to handle without incurring undesirable buffer underruns, which may be overcome by adding controller complexity.

Accordingly, there is a need for a simpler system design which overcomes the aforementioned drawbacks of the prior art.

The present invention overcomes the aforementioned drawbacks and provides an optical disk playback apparatus for use in an optical disk reproducing system.

According to an aspect of the present invention, a playback apparatus for use in a reproducing system including a plurality of play modes, includes in one embodiment: a cache memory configured to store data to be read from a data source; a cache replacement unit configured to identify certain of said stored data to be deleted from the cache memory based on a determination of said stored data's present and/or future use in at least two play modes from among said plurality of play modes; and a presentation unit configured to retrieve data from the cache memory to be presented to a user.

A system of the invention, according to one embodiment, comprises a memory configured to store data to be read from a data source, whereby the data on the data source is configured as a plurality of data blocks; a presentation unit configured to retrieve one or more data blocks from the memory for presentation to a user; a controller configured to manage the contents of the memory and control the operations of the data source, the controller further comprising: a ranking unit operable to rank the desirability of at least two data blocks from among the plurality of data blocks wherein the desirability ranking is based on criteria comprising: each of at least two data blocks predicted future use in at least two of said plurality of play modes and the relative ranking of said at least two of said plurality of play modes.

The playback apparatus of the invention advantageously uses a cache memory in lieu of a conventional FIFO buffer to store data retrieved from an optical disk capable of storing a contiguous or non-contiguous data stream. The advantages over a conventional FIFO buffer include: making the cache memory randomly addressable to allow selection of data in the cache memory in anticipation of an unpredictable trick mode transition, and allowing the stored data to remain in the cache in anticipation of future trick mode transitions.

The foregoing features of the present invention will become more readily apparent and may be understood by referring to the following detailed description of an illustrative embodiment of the present invention, taken in conjunction with the accompanying drawings, where:

FIG. 1 is an illustration of a partial MPEG stream including a plurality of fragments in accordance with the prior art;

FIG. 2 is a block diagram of a video disk reproducing system for playing back an optical disk in accordance with the prior art;

FIG. 3 is more detailed illustration of a playback unit of the system of FIG. 2;

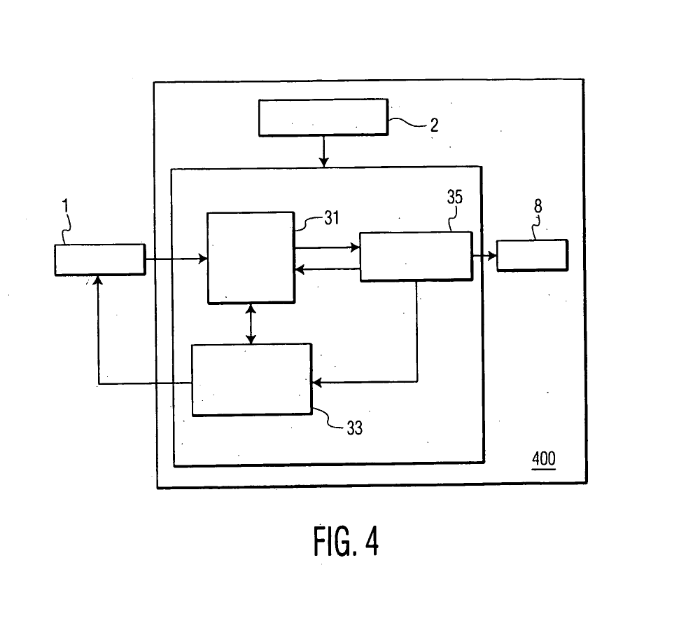

FIG. 4 is a block diagram depicting a video disk playback system for playing back an optical disc according to one embodiment of the invention; and

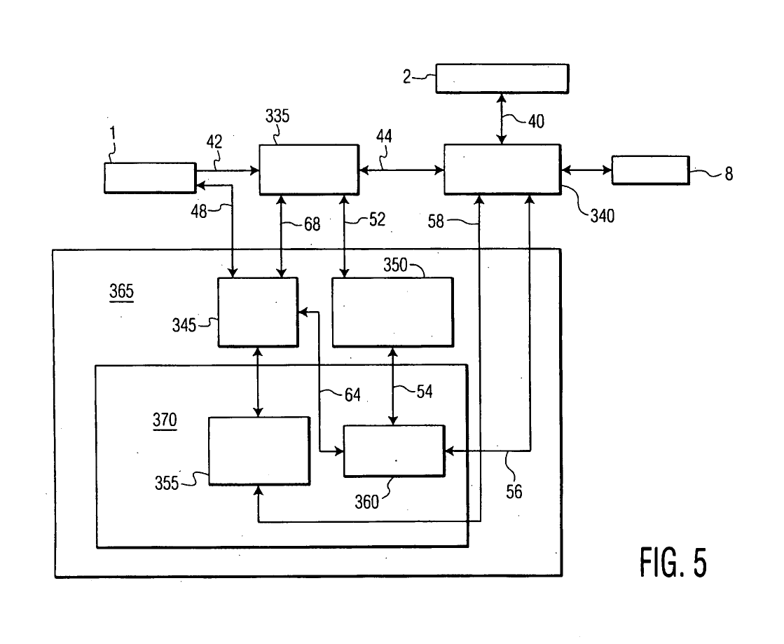

FIG. 5 is more detailed illustration of a playback unit of FIG. 4.

Although the following detailed description contains many specifics for the purpose of illustration, one of ordinary skill in the art will appreciate that many variations and alterations to the following description are within the scope of the invention.

Accordingly, the following preferred embodiment of the invention is set forth without any loss of generality to, and without imposing limitations upon, the claimed invention.

It is contemplated that the disclosed systems, methods and apparatus may find general applicability to any device having a capability of playing back multimedia content from a disc. The playback apparatus of the invention is particularly applicable if the apparatus subscribes to at least the following criteria:

(1) the apparatus uses a disc drive with a slow random access response time or any other medium having a slow random access latency. For example, a wide area network link, especially when routed through satellites;

(2) the apparatus uses a disc format where the content is not always assumed to be laid out linearly; and

(3) the apparatus has a limited memory budget such as a consumer electronic device (i.e., hand-held computers, pocket-sized computers, personal digital assistants, mobile phones and other electronic devices).

The playback apparatus of the invention may be described in the general context of computer-executable instructions, such as program modules, being executed by a microprocessor. Generally, program modules include routines, programs, objects, components, data structures, and so forth. Computer storage media defined herein includes but is not limited to, CD-ROM, digital versatile disks (DVD) or other optical disk storage, or any other medium which can be used to store the desired information and which can accessed by the computer.

A disc playback system is described that supports lower latency trick mode transitions. In the embodiments that follow, a number of features are described which distinguish the present invention over the prior art.

One feature of the present invention is the use of a predictive “trick mode” cache as opposed to a conventional cache of the prior art. The trick mode cache of the invention stores fragments received from the disc drive under control of the disc control unit. A predictive cache differs from a conventional cache in that a conventional cache only defines a cache replacement algorithm, such-as a least recently used (LRU) replacement policy. By contrast, a predictive cache is filled by a separate mechanism that tries to predict future requests. That mechanism is an access prediction unit which utilizes a ranking system to predict which fragments are most likely to be accessed in the future by the presentation unit. It is noted, however, that the ranking may not necessarily reflect the best possible prediction with respect to fragments most likely to be accessed. Instead, in accordance with embodiments of the invention; a skewed ranking may be used to favor particular play modes or play mode transitions that are considered important, even though they may not occur with the highest probability.

In a related aspect, while prior art systems typically make predictions by a process of simple extrapolation of the current play mode, the inventor has recognized that a better prediction of future fragments which are likely to be requested is possible by not just taking into account the current play mode, but by also considering other play modes that a user might switch to in the future.

Another related feature of the invention is the consideration of more than just the present play mode when predicting fragments which are likely to be requested in the future. In one embodiment, the invention extrapolates those fragments which are likely to be requested in two or more play modes which can-then be interleaved in a manner that takes into account the expected probability of each play mode occurring at some point in the future.

In a related aspect, the functioning of the access prediction unit of the invention can be realized in a more practical way by only considering play mode extrapolations that start from the current fragment position and not those that start from all possible future fragment positions.

Another feature of the present invention is that the disc control unit and the cache replacement unit both use the same ranking decision processes (i.e., algorithms) when making ranking decisions on fragments. This is in contrast to the prior art where these two units are less strongly coupled. In the prior art, the disc control unit typically uses a particular ranking of fragments (implicit or explicit), and the cache replacement unit uses a different ranking of fragments. The non-aligned ranking methodologies of the disc control and cache replacement units in the prior art can lead to difficulties in analyzing overall system behavior, especially where mode switches are concerned. By contrast, because the disc control unit and the cache replacement units both use the same ranking methodology when making decisions, the analysis of the overall system behavior can start from the assumption that the contents of the trick mode cache tends to be those fragments that have the highest ranking. This makes the analysis of the case where a mode switch is performed where the system has been in a single mode for some time, and then switches to another mode, fairly straightforward. By allowing for a straightforward analysis, the designer is able to allow for greater variability in the ranking functions used, while still being able to guarantee that certain playback quality criteria are always met.

FIG. 4 illustrates a high-level block diagram of a disc playback system 400 in accordance with an embodiment of the invention. The disc playback system 400 includes a disk drive 1, a user interface 2, a playback unit 6 and an external display 8. Playback unit 6 is comprised of trick mode cache 31, cache and disc control unit 33 and presentation unit 35.

FIG. 5 is a more detailed block-diagram of the disk playback system 400 of FIG. 4 in accordance with an embodiment of the invention. FIG. 5 illustrates the modules which comprise cache and disc control unit 33 of the disk playback system 400 of FIG. 4.

The following description describes the overall operation of the novel playback system 500 shown in FIG. 5, according to one embodiment, by providing a functional description of the units which comprise the system 500.

### Trick Mode Cache 335

The trick mode cache 335 interfaces with the disc drive 1 via line 42, the memory management unit 350 via line 52, the presentation unit 340 via line 44 and the disc control unit via line 68.

The trick mode cache 335 stores the fragments received from the disc drive 1 under control of the disc control unit 345. Any one of the fragments stored in the trick mode cache 335 may eventually be requested by the presentation unit 340 on line 44 at a future time.

A feature of the trick mode cache 335 is that it may be randomly addressed by the presentation unit 340 to request fragments in anticipation of a transition to any of the allowable trick and/or play modes. This capability was unavailable in the prior art playback unit employing a FIFO buffer. It is noted that in alternate embodiments, the trick mode cache 335 may be addressed to request data segments other than fragments, such as disc sector numbers.

Another feature of the trick mode cache 335 is that when the presentation unit 340 requests a fragment for display, the retrieved fragment is not automatically deleted or purged from the trick mode cache 335. This feature is provided in anticipation of a transition to any of the allowable trick and/or play modes.

Another feature of the trick mode cache 335 is that it is a predictive cache which differs from a conventional cache in that a conventional cache is only filled when the user of the cache requests a piece of data not already present in the cache. By contrast, a predictive cache is filled by a separate mechanism that tries to predict future requests.

Another feature of the trick mode cache 335 is that there is no implied requirement on the control logic surrounding the cache to ensure that, if the presentation unit 340 requests data (e.g., one or more fragments), the requested data has to be present and available in the cache. This is different from conventional FIFO solutions in-which the requested data must be present in the FIFO buffer. Whenever requested data is not present in the cache, a cache miss will occur and the presentation unit 340 will continue to output the last frame of the most recently displayed fragment (i.e., freeze frame).

### Presentation Unit 340

Presentation unit 340 interfaces with the user interface 2 via line 40, the trick mode cache 335 via line 44, the display 8 via line 46, the ranking unit 360 via line 56 and the candidate identifier unit 355 via line 58.

The presentation unit 340, in one aspect, includes a timing mechanism that initiates the presentation of successive fragments, as required by modes such as “Play” and “FF”.

The presentation unit 340 presents the current fragment and makes requests for fragments from the trick mode cache 335 on line 44 for display on external display 8.

In the event a request for a fragment made by the presentation unit 340 cannot be satisfied because the fragment is not currently stored in the trick mode cache 335 (i.e., a cache miss), the presentation unit 340 compensates for the missing data by continuing to output the last frame of the most recently displayed fragment (i.e., freeze frame). After a number of successive cache misses in PLAY mode, the timing mechanism might advance the fragment position ‘30 seconds ahead’ in an attempt to jump over a bad area on the disc. It is noted that such heuristic manipulations of the current playback position are well known in the art.

Controller 365

The controller 365 is configured to manage the contents of the trick mode cache 335 and control the actions of the disc drive 1. It includes three sub-units, namely, a disc control unit 345, a memory management unit 350, and an access prediction unit 370 which is further comprised of a candidate identifier unit 355 and a ranking unit 360. Each will be described as follows.

Access Prediction Unit 370

The Access Prediction Unit 370 is comprised of a ranking unit 360 and a Candidate Identifier Unit 355. Each are described as follows.

Ranking Unit 360

The ranking unit 360 interfaces with the memory management unit 350 via line 54, the presentation unit 340 via line 56 and the disc control unit 345 via line 64;

The ranking unit 360 ranks the desirability of at least two fragments among the totality of fragments stored on the disc drive 1. Note that some of the fragments on the disc drive 1 may also be simultaneously stored in the trick mode cache 335 at any point in time. However, whether or not a fragment is presently stored in the trick mode cache 335 is not relevant to the decision processes of the ranking unit 360.

Ranking involves assigning to each fragment of a content source, i.e., disk drive 1, a desirability metric that measures the desirability of fetching or keeping a fragment in the trick mode cache 335. A higher assigned desirability metric corresponds to a higher ranking. In one embodiment, the same desirability metric is used for both disc access (decisions about fetching) and cache replacement (decisions about keeping or removing a fragment in the cache). Other embodiments may choose to use different desirability metrics for fetching and keeping fragments.

In one embodiment, the desirability metric is derived based on two considerations. A first consideration for deriving the desirability metric is directed to the probability that a fragment will be fetched by the presentation unit 340 at some point in the future. The more probable that a fragment will be fetched at some point in the future, the more desirable the fragment. A second consideration concerns the time at which the fragment will be fetched in the future. A fragment fetched closer to the present time is considered more desirable than a fragment fetched further in the future.

The first consideration, i.e., the probability of a fragment being fetched in the future, can be expressed as a probability function as follows:

pf(f)=probability that a fragment f will be requested at a future time by the presentation mechanism. (1)

The probability function of Eq. (1) can incorporate the second consideration, i.e., time, as follows:

pf (t,f)=probability that a fragment f will be requested at a future time by the presentation mechanism at a time t. (2)

Using Eq. (2), desirability can be expressed as follows:

$$d ( f ) = {\int }_{t = 0}^{t = ∞} w ( t ) pf ( t , f ) \qquad ( 3 )$$

Where w(t) is a time-based weighting function that takes the second consideration, i.e., time, into account. The value of time-based weighting function w(t) is lower if t is further into the future. An exemplary weighting function would be:

w(t)=1/(1+t). (4)

In a practical implementation, it is desirable to approximate the desirability metric of Eq. (2).

Recall from the discussion above that, in the prior art, only the current play mode is extrapolated. Such an extrapolation of the current play mode can be formalized as an approximation function d1(f):

$$d ( f ) \approx d 1 ( f ) = {\int }_{t = 0}^{t = ∞} w ( t ) pf ( M , t , f ) \qquad ( 5 )$$

### Where:

M—represents the current play mode of operation, and,
pf(m,t,f)—represents the probability that a fragment f will be requested at a future time by the presentation mechanism at a time t in play mode m, where

pf(m,t,f)=1 if, extrapolating from the current playback position, while operating in the play mode “m”, fragment “f” is accessed by the presentation mechanism at time t

pf(m,t,f)=0 otherwise.

It is noted that the function pf(m,t,f) represents a calculation that is easy to implement, i.e., having a value of either zero or one is a simple extrapolation of the current play mode.

The ranking algorithm of the current embodiment improves on the prior art approximation d1(f) by taking multiple modes into account. The resulting approximation d2(f) can be defined as follows:

$$d ( f ) \approx d 2 ( f ) = {\sum }_{m ∈ MODES} {\int }_{t = 0}^{l = ∞} pm ( m , t ) w ( t ) pf ( m , t , f ) \qquad ( 6 )$$

where
MODES is the set of all play modes
pm(m,t) is a probability function of two parameters, a mode identifier m and a time t. The probability function determines the probability that the system will be in playback mode m at time t.
The pf(m,t,f) function is as defined above
w(t) is as defined above.

Eq. (6) illustrates an approximation function for implementing a ranking algorithm in accordance with the principles of the invention.

In one embodiment, the value of pm(m,t) above is computed using a table lookup. By way of example, assume that a device includes the following play modes:

Play,

FF4 (fast forward at 4× speed),

FF16 (fast forward at 16× speed),

FR4 (fast reverse at 4× speed),

FR16 (fast reverse at 16× speed).

Recall that, as described above, the function values of pm(m,t) reflect the probability that the device will be in a certain play mode ‘m’ in the future at time ‘t’. To compute pm(m,t), a number of steps are performed. In one embodiment, a table lookup is used to determine four play modes that are most probable for the device to be operating in in the near future. The play modes are ranked in decreasing order based on a probability score. It is assumed that the current play mode is always the most probable play mode for the device to be operating in in the near future. Assume the current play mode is mode A. What is required is to determine which play modes (e.g., FF16, FF4, FR4 and so on) will be associated with B, C and D where B is the play mode most likely to be switched to, play mode C is the next most likely play mode to be switched to and play mode D is the next most likely play mode to be switched to.

Assume that, apart from knowing the current play mode A, it is also known whether or not the user switched to another play mode in the last five seconds. With this information, the first two columns of table 1 are used to find a particular row that matches the current play mode and yes/no information on whether the mode was switched in the last 5 seconds. For example, if A is the current mode ‘play’ and if the user did not switch modes in the last 5 seconds, then the second row in table 1 is selected. The second row is then used to determine the play mode values for B, C, and D (e.g., B=FF4, C=FF16 and D=FR16).

TABLE 1

| Was mode | | | | |
|---|---|---|---|---|
| changed in the | A | | | |
| last 5 seconds (to | (current | | | |
| mode A)? | mode) | B = | C = | D = |
| Yes | Play | FF4 | FR4 | FF16 |
| No | Play | FF4 | FF16 | FR16 |
| Yes | FF16 | FR4 | Play | FF4 |
| No | FF16 | FR4 | Play | FF4 |
| Yes | FR16 | Play | FF4 | FR4 |
| No | FR16 | FF16 | Play | FR4 |
| Yes | FF4 | Play | FR4 | FF16 |
| No | FF4 | FF16 | Play | FR16 |
| Yes | FR4 | Play | FF4 | FR16 |
| No | FR4 | FR16 | Play | FF16 |

Using the values of A, B, C, and D obtained above, the function pm(m,t) is computed as follows:

$$pm ( m , t ) = 〈 \begin{matrix}1.00 if m = A , else \\ 0.50 if m = B , else \\ 0.25 if m = C , else \\ 0.20 if m = D , else \\ 0 in all other cases\end{matrix} \qquad ( 7 )$$

As discussed above, play mode A is the most likely future play mode for the device. As such, equation (7) assigns a probability metric of 1.00 to this mode. For mode B, the metric is lower, at 0.50, indicating that the likelihood of operating in this mode in the future is lower, and so on. It is noted that the probability function pm(m,t) is a probability function in two variables, i.e., m and t, however, in the present embodiment, the time variable t is not considered in the calculation. The table values of Table I may be assigned during a set-up or pre-configuration stage. The table values may be assigned in one way by considering the likely behavior of the user in selecting play modes under certain circumstances. An alternative method would be to study the behavior of actual users, and use the (statistical) results of that study to determine the table values.

Step two above, i.e., table lookup, is based on considering two criteria: (1) the current play mode (column 2) and (2) information about whether the play mode was recently changed (column 1). It should be noted that alternative embodiments may use additional or different lookup criteria (combined with a different table). For example, both the identity of the current mode and the previous mode could be used.

The present invention combines a trick mode cache with a presentation mechanism that can deal with cache misses in an elegant manner by doing a freeze-frame in the event of a cache miss. This feature allows for great flexibility in the ranking unit (and the table that can be used therein), because the ranking unit is not constrained by design criteria that a cache miss should never occur. This flexibility can be beneficially exploited by embodiments that modify the ranking calculations performed by the ranking unit (for example by modifying the table) with the aim of tailoring the functioning of the device more closely to the particular needs of the user.

One possible embodiment for modifying the ranking calculation is directed to updating the table while the device is operational. In particular, the user's behavior is measured and the table is updated so that it matches the measured user behavior more closely.

Another possible embodiment for modifying the ranking calculation, allows the user to change the table via a configuration mechanism (e.g. an on-screen menu). The user might select alternative versions of the table contents, or even edit individual table entries.

As a particular example, a user who frequently uses the ‘FR16’ mode but uses the ‘FR4’ mode less frequently, can modify the table to create an overall lower function value pm(m,t) for m=FR4. This modification could be implemented, for example, by deleting all of the FR4 entries in the table and replacing them with FR16 entries. This results in a situation where fragments that are useful for the FR4 mode, but not for the FR16 mode, have a lower ranking, and therefore a lower probability to be read or retained in the trick mode cache. This in turn means that there is more room in the cache for fragments of the FR16 mode. By having more fragments for the FR16 mode in the trick mode cache, the playback quality perceived by the user when that mode is switched to is improved. Depending to on the implementation chosen for the presentation unit, the switch will a) will happen faster, or b) be accompanied with fewer freeze frame situations because a needed fragment is not (yet) in the cache, or c) a combination of a) and b).

Candidate Identifier Unit 355

The candidate Identifier Unit 335 interfaces with the disc control unit 345 via line 50 and with the presentation unit 340 via line 58.

The disc control unit 345 uses the ranking of fragments on the disc drive 1, as determined by the ranking unit 360, as one input to determine which fragment(s) should be read from disc. Given the totality of fragments stored on the disc drive 1, which is exceedingly large, it is impractical to have the ranking unit consider them all. As a practical solution, a mechanism is employed that considers only a subset of the totality of fragments for consideration as candidate fragments for access by the disc control unit 345 in the future. In one embodiment, the candidate identifier unit 355 identifies a subset of fragments for consideration as candidate fragments for access in the future. Once the candidate fragments have been identified by the candidate identifier unit 355, the ranking unit 360 ranks the candidate fragments based on their respective assigned desirability metrics.

To give a more concrete example, in one embodiment, the candidate identifier unit will compute, for each play mode, a set of 10 fragment identifiers, and then deliver the union of all sets as the set of candidate fragments for consideration by the ranking unit 360. To compute the 10 fragment identifiers for a particular mode, the read actions of the presentation unit, if it were in that mode starting from the current fragment position of the presentation unit, are extrapolated.

Memory Management Unit 350

The memory management unit 350 interfaces with the trick mode cache 335 via line 52 and with the ranking unit via line 54.

The memory management unit 350 selects which fragments to delete from the trick mode cache 335 when storage is needed to store fragment data received from the disc drive 1 in response to an instruction from the disc control unit 345 to read fragment data. The decision as to which fragments are to be deleted from the trick mode cache 335 takes into consideration the relative desirability of each fragment currently stored in the trick mode cache 335, as determined by the ranking unit 360. The fragment with the lowest desirability is deleted. If more storage is required after deleting the lowest desirability fragment, then the fragment with the second-to-lowest desirability is deleted, and so on until there is sufficient free storage space in the trick mode cache 335.

Disc Control Unit 345

The disc control unit 345 interfaces with the disc drive 1 via line 48, with the candidate identifier unit 355 via line 50, with the trick mode cache via line 68 and with the ranking unit 360 via line 64.

Upon selecting one or more fragments from the disc drive 1 in accordance with one of the approaches to be described below, the disc control unit 345 then instructs the disc drive 1 on line 48 to retrieve the one or more selected fragments using one or more commands in the command language appropriate for the disc drive 1. Responsive to these commands, the disc drive 1 outputs the retrieved fragment(s) to the trick mode cache 335 on line 56.

One approach for the disc control unit 345 to select fragments from the disc drive is as follows. The candidate identifier unit 355, which is a part of the Access Prediction unit 370, identifies some number of fragments on the disc drive 1 for consideration as candidate fragments to be accessed in the future. Once the candidate fragments have been identified by the candidate identifier unit 355, the ranking unit 360 ranks the identified fragments in accordance with each fragment's computed desirability metric. In one embodiment, the ranked set of candidate fragments is implemented as a list, referred to as a ‘fragment list’ which is output from the access prediction unit 370 and sent to the disc control unit 345. The list contains the fragments in order of desirability, with the most desirable fragment listed first. The disc control unit 345 then utilizes a fragment selection algorithm to select a single fragment from the ‘fragment list’ to read from the disc drive 1.

The disc control unit 345 then instructs the disc drive 1 on line 48 to retrieve the selected fragment using one or more commands in the command language appropriate for the disc drive 1. Responsive to these commands, the disc drive 1 outputs the retrieved fragment to the trick mode cache 335 on line 42.

The process of selecting a single fragment from the fragment list in accordance with a fragment selection algorithm implemented by the disc control unit 343, according to one embodiment, is now described.

The fragment selection algorithm has knowledge of the current contents of the trick mode cache 335. Knowing its contents, the algorithm first reviews the contents of the fragment list {f₁, f₂, f₃, f₄, . . . } and eliminates all fragments that are already present in the trick mode cache 335. Having eliminated these fragments, the fragment selection algorithm may then utilize any number of approaches to select a single fragment from the narrowed-down fragment list.

A first approach for selecting a single fragment is to pick the first fragment of the narrowed-down list.

A second approach has the additional objective to select a fragment that also optimizes the disc drive seek pattern. This second approach selects a single fragment from the narrowed-down fragment list having the lowest numerical value computed by a tradeoff function T defined as:

T (distance of fₓ to start of list, distance of fₓ to current disc position) (8)

Equation (8) describes a tradeoff function T which takes as its arguments two computed values for the fragment fₓ from the fragment list. The first computed value is the “distance of the fragment fₓ to the start of the fragment list”. Fragments closer to the head of the fragment list have a greater likelihood of being requested and therefore yield a higher numerical value.

The second computed value, i.e., “distance of fₓ to current disc position”, is the distance of fragment fₓ to the current disc drive read/write head position. The lower the distance, the higher the resulting value.

The tradeoff function T computes both values and returns a weighted combination of the two computed values for each element f in the fragment list. This weighted combination is an increasing function in both arguments, meaning that T(X,Y) yields a higher function value both if X is increased and if Y is increased. An example of an appropriate T is T(X,Y)=X+C*Y, with C a constant. The exact parameters of the weighting function T (e.g., the constant C) are tuned or determined in such a way as to create an optimal seek pattern, given the specific performance parameters of the disc drive 1.

As previously stated, a single fragment is then selected from the narrowed down fragment list having the lowest numerical value computed by the tradeoff function T.

It is noted that the generation of a fragment list represents one way to perform the function of the disc controller. Other representations for ranking fragments are also within contemplation of the invention.

### Access Prediction Unit 370—Second Embodiment

In the previous embodiment of the access prediction unit 370, a fragment list is constructed for use by the disc control unit 345 by first creating a set of fragment candidates, ranking the set of fragment candidates, and then creating an ordered list based on the ranking. In the present embodiment of the access prediction unit 370, the fragment list is constructed in the access prediction unit 370 in a relatively more straightforward way by using a technique that involves the interleaving of lists, to be described below. In the present embodiment, the access prediction unit 370 is not comprised of two internal sub-units, instead a single algorithm creates a ranked candidate list for use by the disc control unit 345. The memory management unit 350 can also make use of this ranked candidate list; the modifications needed in the memory management unit 350 should be apparent to one of ordinary skill in the art. Such modifications to the memory management unit 350 in accordance with a ranked candidate list are discussed in related application Ser. No. 60/507,091 identified above.

In the present embodiment, as a first step, four play modes A-D are selected using the table-driven approach describe above. Then, for each of these four play modes, extrapolation is used, as described above for the candidate identifier unit 355, to create a fragment list for each play mode A-D. A fragment list for the ith play mode may be generally represented as: FLᵢ={fi₁, fi₂, fi₃, fi₄, . . . }, with fi being the fragment that is first access by the presentation unit 340 in the future in the ith play mode, fi₂ being the second fragment, and so on.

As a second step, having created a fragment list, FLᵢ for each of the respective play modes A-D, in accordance with the present embodiment, the respective fragment lists are then interleaved in a particular (weighted) way. The resulting interleaved list is the desired “fragment list”, containing the fragments in order of desirability. This is generally illustrated now by way of example.

### EXAMPLE

Consider four possible play modes, i.e., play modes A through D, which could represent, for example, FF4, FR4, Play and FF16. The fragment list for each of the respective play modes could be arbitrarily represented as:

play mode A=FL_{A}={f_{A1}, f_{A2}, f_{A3}, f_{A4}, f_{A5}, f_{A6}, f_{A7}, f_{A8} . . . }; [current play mode]

play mode B=FL_{B}={f_{B1}, f_{B2}, f_{B3}, f_{B4}, f_{B5}, f_{B6}, . . . };

play mode C=FL_{C}={f_{C1}, f_{C2}, f_{C3}, f_{C4} . . . }; and

play mode D=FL_{D}={f_{D1}, f_{D2}, f_{D3}, f_{D4}, f_{D5}, f_{D6}, f_{D7} . . . };

Where play mode A represents the current play mode, play mode B represents the play mode most likely to be switched to, play mode C represents the next play mode most likely to be switched to after play mode B and play mode D represents the next most likely play mode to be switched to after play mode C. The length of each of the fragment lists is implementation dependent. For good results, the implementer should make each fragment FLᵢ list so long that the sum of the sizes of the fragments in FLᵢ is greater than the size of the trick mode cache memory 335.

An exemplary interleaved list may be created in a “weighted” way as follows. As a first weighting step, the interleaved list may be initially created by first adding the first four elements from FL_{A}, corresponding to play mode A. A partial interleaved list at this point is as follows:

FL_{interleaved(partial)}={f_{A1}, f_{A2}, f_{A3}, f_{A4}, ______, ______, ______, . . . }

Next, to fill out the interleaved list, add two elements each from the lists A and B, one element each from lists C and D, and repeat this step until all list elements have been exhausted, thereby creating the completed interleaved list.

It is to be appreciated that, in addition to other types of weighting, a conscious “weighting” of the list has been achieved by putting four elements from FL₁ on the interleaved list first. This is to ensure some minimal level of filling of the trick mode cache 335 for the current mode of operation, play mode “A”. This filling of the trick mode cache 335 is to ensure a more streamline process in the current mode of operation, in anticipation of the possibility of incidental delays of the disc drive (e.g., delays due to “jumps” in sequential storage of the fragments stored on the disc, temporary loss of tracking by the basic engine, etc.)

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A playback apparatus for use in a reproducing system which includes a plurality of play modes, comprising:
a memory (335) configured to store data to be read from a data source (1), said data configured as a plurality of data blocks on said data source (1);
a presentation unit (340) configured to retrieve one or more data blocks from the memory (335) for presentation to a user;
a controller (365) configured to manage the contents of the memory (335) and control the operations of said data source (1), said controller comprising:
a ranking unit (360) operable to rank the desirability of at least two data blocks from among said plurality of data blocks wherein said desirability ranking is based on criteria comprising: (i) each of said at least two data blocks predicted future use in at least two of said plurality of play modes and (ii) the relative ranking of said at least two of said plurality of play modes.

2. The playback apparatus of claim 1, wherein said desirability ranking criteria of each of said at least two data blocks predicted future use in at least two of said plurality of play modes further comprises determining a time of said predicted future use.

3. The playback apparatus of claim 1, wherein said relative ranking of said at least two of said plurality of play modes is based on the probability of the playback apparatus remaining in or switching to said at least two of said plurality of play modes at a future time.

4. The playback apparatus of claim 1, wherein said relative ranking of said at least two of said plurality of play modes is based on a user's past usage patterns of said at least two of said plurality of play modes.

5. The playback apparatus of claim 1, wherein said relative ranking of said at least two of said plurality of play modes is based on a current play mode and whether a recent play mode change has occurred.

6. The playback apparatus of claim 1, wherein said relative ranking of said at least two of said plurality of play modes is based on a user's play mode preferences.

7. The playback apparatus of claim 1, further comprising a disc control unit (345) in communication with said ranking unit (360), said disc control unit (345) configured to use at least said desirability ranking to determine which of said plurality of data blocks to retrieve from said data source (1).

8. The playback apparatus of claim 1, wherein said controller (365) further comprises a memory management unit (350) in communication with said ranking unit (360), said memory management unit (350) configured to delete data blocks from said memory (335).

9. The playback apparatus of claim 8, wherein those data blocks having the lowest relative ranking in said memory (335) are selected for deletion by said memory management unit (350).

10. The playback apparatus of claim 9, further comprising a disc control unit (345) in communication with said ranking unit (360), said disc control unit (345) configured to use at least said desirability ranking to determine which of said plurality of data blocks to retrieve from said data source (1).

11. The playback apparatus of claim 10, wherein said memory management unit (350) and said disc control unit (345) utilize the same fragment ranking criteria.

12. The playback apparatus of claim 1, further comprising a candidate identifier unit (355) configured to select a set of candidate blocks from said plurality of data blocks on said data source (1) for consideration by said ranking unit (360) and said disc control unit (345).

13. The playback apparatus of claim 12, wherein said set of candidate blocks is selected by said candidate identifier unit (355) by extrapolating, for said at least two play modes, the data blocks to be read by said presentation unit (340) during operation in each of said at least two play modes.

14. The playback apparatus of claim 13, wherein said extrapolation begins substantially near a block that is currently being presented by said presentation unit (340).

15. A playback apparatus for use in a reproducing system which includes a plurality of play modes, comprising:
a memory (335) configured to store data to be read from a data source (1), said data configured as a plurality of data blocks on said data source (1);
a presentation unit (340) configured to retrieve one or more data blocks from the memory (335) for presentation to a user;
a controller (365) configured to manage the contents of the memory (335) and control the operations of said data source (1), said controller comprising:
a ranking unit (360) operable to rank the desirability of at least two data blocks from among said plurality of data blocks wherein said desirability ranking is determined from: (i) extrapolating data block usage in said at least two of said plurality of play modes and (ii) interleaving the extrapolations.

16. The playback apparatus of claim 15, wherein said interleaving the extrapolations is based on the probability of the playback apparatus remaining in or switching to said at least two of said plurality of play modes at a future time.

17. The playback apparatus of claim 15, wherein said act of interleaving the extrapolations is based on a user's past usage patterns of said at least two of said plurality of play modes.

18. The playback apparatus of claim 15, wherein said act of interleaving the extrapolations is based on a current play mode and whether a recent play mode change has occurred.

19. The playback apparatus of claim 15, wherein said act of interleaving the extrapolations is based on a user's play mode preferences.

20. The playback apparatus of claim 15, further comprising a disc control unit (345) in communication with said ranking unit (360), said disc control unit (345) configured to use at least said desirability ranking to determine which of said plurality of data blocks to retrieve from said data source (1).

21. The playback apparatus of claim 15, wherein said controller (365) further comprises a memory management unit (350) in communication with said ranking unit (360), said memory management unit (350) configured to delete data blocks from said memory (335).

22. The playback apparatus of claim 15, wherein those data blocks having the lowest relative ranking in said memory (335) are selected for deletion by said memory management unit (350).

23. The playback apparatus of claim 15, further comprising a disc control unit (345) in communication with said ranking unit (360), said disc control unit (345) configured to use at least said desirability ranking to determine which of said plurality of data blocks to retrieve from said data source (1).

24. The playback apparatus of claim 15, wherein said memory management unit (350) and said disc control unit (345) utilize the same fragment ranking criteria.

25. The playback apparatus of claim 15, further comprising a candidate identifier unit (355) configured to select a set of candidate blocks from said plurality of data blocks on said data source (1) for consideration by said ranking unit (360) and said disc control unit (345).

26. The playback apparatus of claim 25, wherein said set of candidate blocks is selected by said candidate identifier unit (355) by extrapolating, for said at least two play modes, the data blocks to be read by said presentation unit (340) during operation in each of said at least two play modes.

27. The playback apparatus of claim 26, wherein said extrapolation begins substantially near a block that is currently being presented by said presentation unit (340).

28. A method of ranking the desirability of at least two data blocks from among a plurality of data blocks of a data source, for use in a playback apparatus having a plurality of play modes, the method comprising the acts of:
(i) determining each of said at least two data blocks predicted future use in at least two of said plurality of play modes; and
(ii) determining the relative ranking of said at least two of said plurality of play modes.

29. The method of claim 28, wherein said act of determining each of said at least two data blocks predicted future use in at least two of said plurality of play modes further comprises the act of determining a time of said predicted future use of said each of said at least two data blocks.

30. The method of claim 28, wherein said act of determining the relative ranking of said at least two of said plurality of play modes further comprises computing the probability of the playback apparatus remaining in or switching to said at least two of said plurality of play modes at a future time.

31. The method of claim 28, wherein said act of determining the relative ranking of said at least two of said plurality of play modes further comprises determining a user's past usage patterns of said at least two of said plurality of play modes.

32. The method of claim 28, wherein said act of determining the relative ranking of said at least two of said plurality of play modes further comprises determining a current play mode and whether a recent play mode change has occurred.

33. A method of ranking the desirability of at least two data blocks from among a plurality of data blocks of a data source, for use in a playback apparatus having a plurality of play modes, the method comprising the acts of:
(i) extrapolating data block usage in said at least two of said plurality of play modes; and
(ii) interleaving the extrapolations.

34. The method of claim 33, wherein said act of interleaving the extrapolations further comprises the act of determining a time of said predicted future use of said each of said at least two data blocks.

35. The method of claim 33, wherein said act of interleaving the extrapolations further comprises computing the probability of the playback apparatus remaining in or switching to said at least two of said plurality of play modes at a future time.

36. The method of claim 33, wherein said act of interleaving the extrapolations further comprises determining a user's past usage patterns of said at least two of said plurality of play modes.

37. The method of claim 33, wherein said act of interleaving the extrapolations further comprises determining a current play mode and whether a recent play mode change has occurred.

38. The method of claim 33, wherein said act of interleaving the extrapolations further comprises determining a user's play mode preferences.
